(19) United States
(12) Patent Application Publication
(10) Pub. No.: US 2011/0185310 A1
(43) Pub. Date: Jul. 28, 2011

(54) METHOD AND SYSTEM FOR DETECTING A FINGER CONTACT ON A TOUCHPAD

(75) Inventors: Xiaoning LIU, Shenzhen (CN); Fan Liu, Shenzhen (CN); Bangjun He, Shenzhen (CN); Yun Yang, Shenzhen (CN)

(73) Assignee: BYD COMPANY LIMITED, Shenzhen (CN)

(21) Appl. No.: 13/004,441

(22) Filed: Jan. 11, 2011

(30) Foreign Application Priority Data
Jan. 27, 2010 (CN) 201010103762.6

(51) Int. Cl. G06F 3/048

(52) U.S. Cl. 715/786; 715/784

(57) ABSTRACT

A method for executing a scroll control operation on a touchpad comprises receiving a first contact signal induced by a first contact with a first section of the touchpad, receiving a second contact signal induced by a second contact with a second section of the touchpad, the first section and second section being predefined in a scrolling region on the touchpad, recording a first direction from the first contact to the second contact, and a first distance between the first section and the second section and outputting a scroll control signal to execute a scroll operation, the scroll control signal including information of the first direction and first distance.

### CROSS-REFERENCE TO RELATED APPLICATION

This application claims foreign priority benefits under 35 U.S.C. § 119 of Chinese Patent Application Serial No. 201010103762.6, filed on Jan. 27, 2010, the content of which is incorporated herein by reference in its entirety.

### TECHNICAL FIELD

The present invention relates generally to a touchpad, and more particularly to a scrolling method for touchpad.

### BACKGROUND

Although the keyboard remains a primary input device of a computer, the prevalence of graphical user interfaces (GUIs) may require use of a mouse or other pointing device such as a trackball, joystick, touchpad or the like.

Touchpads are commonly used on portable electronic devices due to their compact size. FIG. 1 shows a conventional touchpad 10, on which three regions are divided into a cursor control region 11, a horizontal scroll region 12 and a vertical scroll region 13. In operation, cursor control and scrolling control are performed on their respective, specific regions. For example, when a user wants to move a cursor on a corresponding user interface window of a display, the user operates on the cursor control region 11. To view portions of documents outside a user interface window, the user may operate the corresponding scroll regions to scroll the documents upward, downward, leftward or rightward.

### SUMMARY OF THE INVENTION

According to one exemplary embodiment of the invention, a method for executing a scroll control operation on a touchpad is presented. The method comprises receiving a first contact signal induced by a first contact with a first section of the touchpad, receiving a second contact signal induced by a second contact with a second section of the touchpad, the first section and second section being predefined in a scrolling region on the touchpad, recording a first direction from the first contact to the second contact, and a first distance between the first section and the second section and outputting a scroll control signal to execute a scroll operation, the scroll control signal including information of the first direction and first distance.

According to another exemplary embodiment of the invention, a device for executing a scroll control operation on a touchpad is presented. The device comprises a processor configured to receive a first contact signal induced by a first contact with a first section, receive a second contact signal induced by a second contact with a second section, the first section and second section being predefined in a scrolling region on the touchpad, record a first direction from the first contact to the second contact and a first distance between the first section and the second section and output a first scroll control signal to execute a first scroll operation, the first scroll control signal including information of the first direction and the first distance.

According to another exemplary embodiment of the invention, a method for executing a scroll control operation on a touchpad is presented. The method comprises receiving a first contact signal induced by a first contact with a first section of the touchpad, receiving a second contact signal induced by a second contact with a second section of the touchpad, the first section and second section being predefined in a scrolling region on the touchpad, recording a time interval between receipt of the first contact signal and second contact signal, comparing the time interval to a predefined first reference and a predefined second reference, recording a first direction from the first contact to the second contact and a distance between the first section and second section in an instance in which the time interval is less than the second reference and greater than the first reference and outputting a first scroll control signal to execute a scroll operation, the scroll control signal including information of the first direction and first distance.

According to another exemplary embodiment of the invention, a device for executing a scroll control operation on a touchpad is presented. The device comprises a processor configured to receive a first contact signal induced by a first contact with a first section of the touchpad, receive a second contact signal induced by a second contact with a second section of the touchpad, the first section and second section being predefined in a scrolling region on the touchpad, record a time interval between receipt of the first contact signal and second contact signal, compare the time interval to a predefined first reference and a predefined second reference, record a first direction from the first contact to the second contact and a distance between the first section and second section in an instance in which the time interval is less than the second reference and greater than the first reference and output a first scroll control signal to execute a scroll operation, the scroll control signal including information of the first direction and first distance.

### BRIEF DESCRIPTION OF THE DRAWINGS

The foregoing summary, as well as the following detailed description of the invention, will be better understood when read in conjunction with the appended drawings. The embodiments illustrated in the figures of the accompanying drawings herein are by way of example and not by way of limitation. In the drawings:

FIG. 1 illustrates a touchpad device according to the prior art;

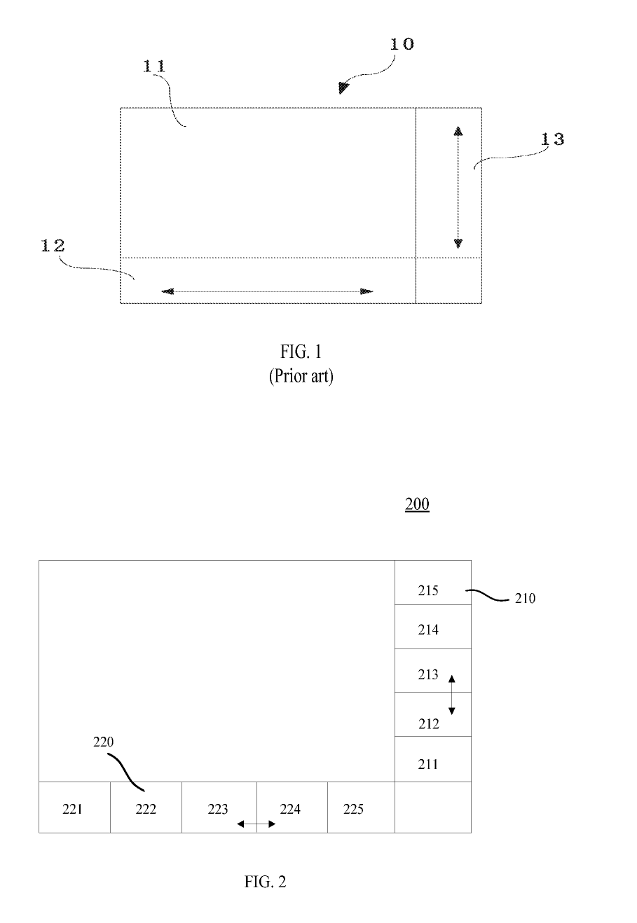

FIG. 2 illustrates a touchpad with predefined sections in scrolling regions according to one exemplary embodiment of the present invention;

FIG. 3 is a flow chart describing a method for executing a scroll control operation on a touchpad device according to one exemplary embodiment of the present invention; and

FIG. 4A-FIG. 4D are schematic diagrams describing a scroll control operation on a touchpad device according to exemplary embodiments of the present invention.

### DETAILED DESCRIPTION OF THE PREFERRED

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, a number of components or objects may be described herein in the singular, plural or as being “at least one” or “one or more.” It should be understood, however, that notwithstanding any particular quantity with which a component or object may be described herein, unless explicitly stated otherwise, the component or object may be in any of a number of different quantities, from the singular to the plural. Like numbers refer to like elements throughout.

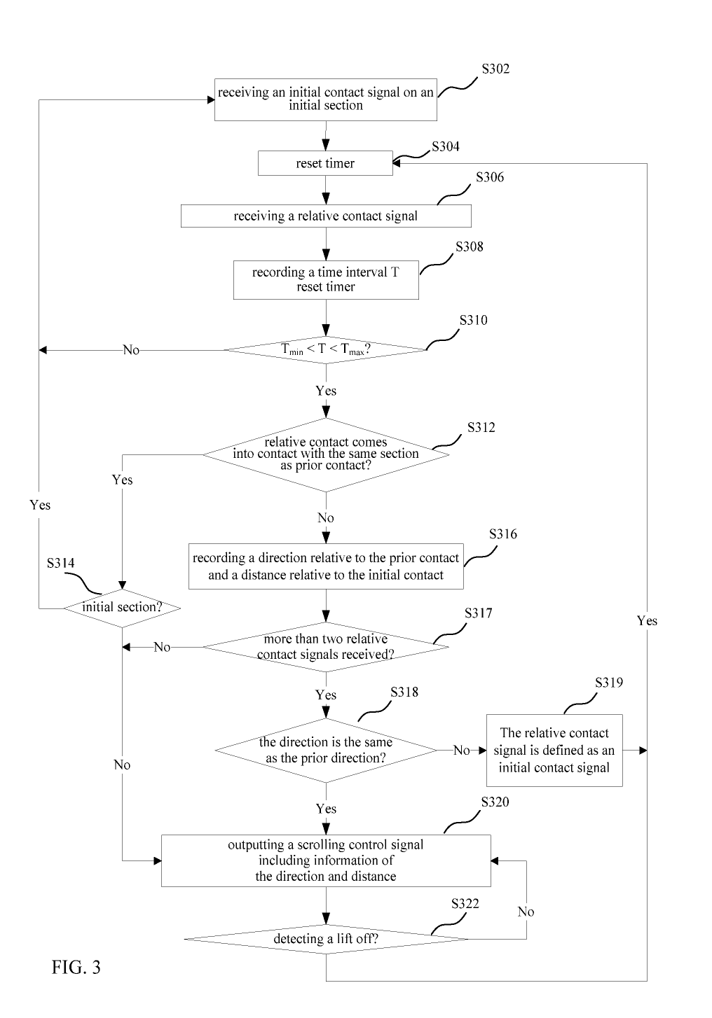

FIG. 2 illustrates a touchpad 200 with predefined sections in scrolling regions according to one exemplary embodiment of the present invention. As illustrated in FIG. 2, a first scrolling region 210 and a second scrolling region 220 are predefined on the touchpad 200. Each of the first scrolling region 210 and the second scrolling region 220 is associated with a respective scrolling direction. For example, the first scrolling region 210 may be associated with a vertical scrolling direction, and the second scrolling region 220 may be associated with a horizontal scrolling direction. A plurality of sections may be predefined in each of the first and second scrolling regions. For example, sections 211, 212, 213, 214 and 215 may be predefined in the first scrolling region 210, and sections 221, 222, 223, 224 and 225 may be predefined in the second scrolling region 220. Although FIG. 2 illustrates each region including five sections, it should be understood that each section may include a greater or lesser plurality of sections; and that the regions may have the same or different numbers of sections.

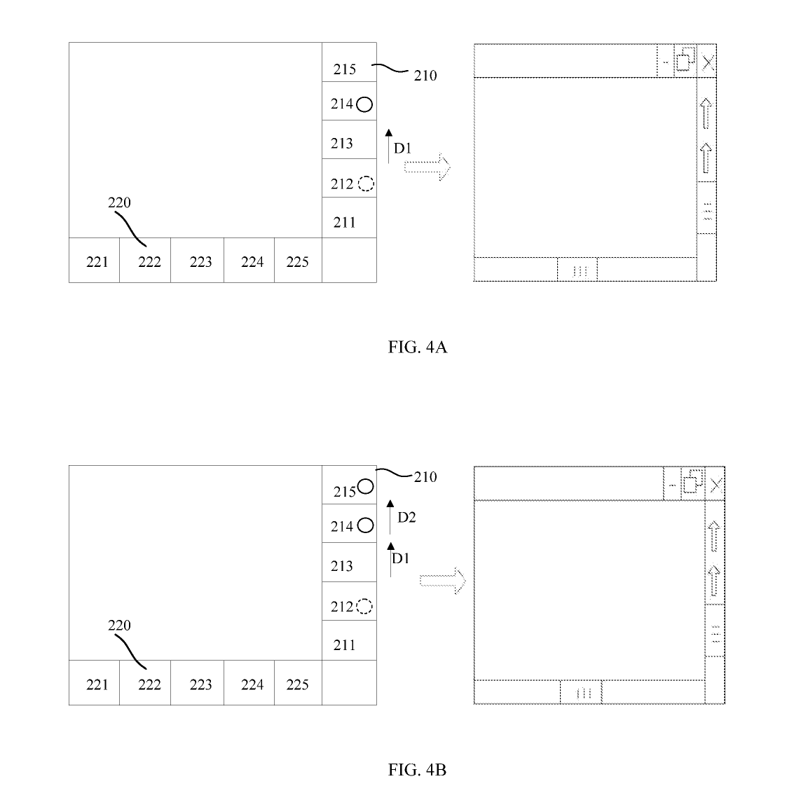

FIG. 3 is a flow chart describing a method for executing a scroll control operation on a touchpad according to one exemplary embodiment of the present invention (“exemplary” as used herein referring to “serving as an example, instance or illustration”). FIG. 3 will be described with respect to executing a scroll control operation in the first scrolling region 210, although it should be understood that the scroll control operation may be equally executed in the second scrolling region 220.

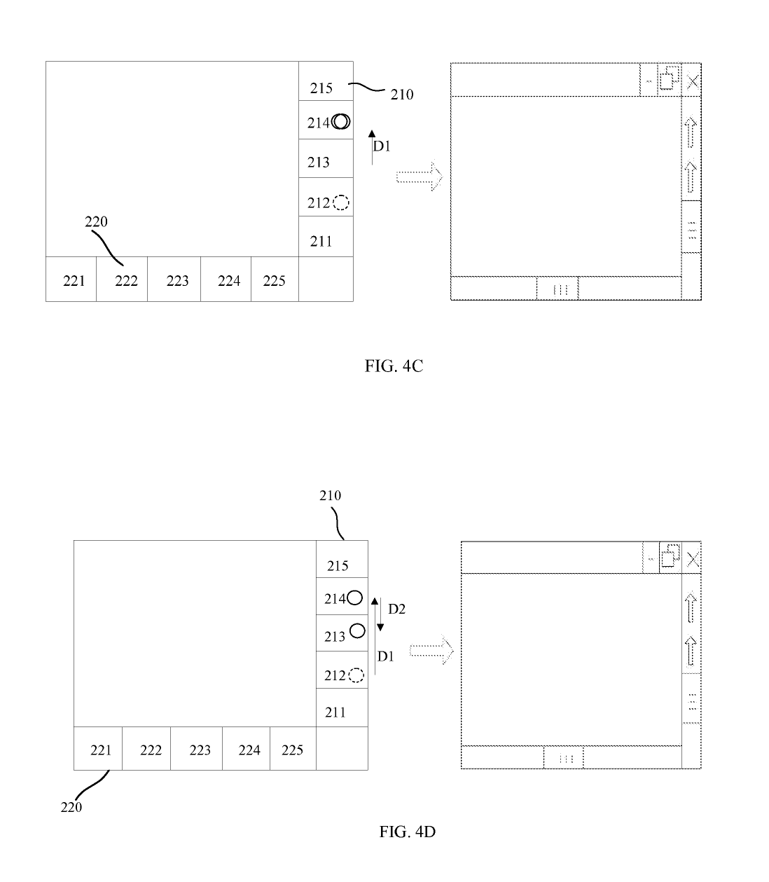

As shown, in a first instance, a pointing object (e.g., a finger or a stylus) comes into contact with a first section (e.g, section 212 referred as an “initial section”) of the first scrolling region 210, as illustrated in FIG. 4A, the contact may induce a sensing unit of the touchpad to generate a first contact signal (referred as an “initial contact signal”), which may be received by a processing unit of the touchpad at step S302. In response to receipt of the first contact signal, the processing unit may reset and restart a timer at step S304. This and similar contact signals may be representative of, and recognized by the processing unit as reflecting, contact with a particular section of the scrolling region, or may be otherwise representative of a point of contact of the object on the touchpad 200. Thus, for example, the processing unit may recognize the first contact signal as reflecting contact with the first section of the first scrolling region 210.

In a second instance, the same or another pointing object may come into contact with a second section (e.g., section 214) in the first scrolling region 210, as also illustrated in FIG. 4A. This second contact may, for example, be the result of the pointing object moving or being moved from the first section (e.g., section 212) to the second section (e.g., section 214). Similar to the first instance, the contact in the second instance may induce the sensing unit to generate a second contact signal (referred as a “relative contact signal”) representative of contact with the second section of the first scrolling region 210. Similar to the first contact signal, the second contact signal may be received by the processing unit at step S306, and may be recognized by the processing unit as reflecting contact with the second section of the first scrolling region 210.

Upon receipt of the second contact signal, the processing unit may stop the timer and record a first time interval T₁ between receipt of the first contact signal and the second contact signal at step S308. The processing unit may compare the first time interval T₁ to a first reference Tₘᵢₙ and a second reference Tₘₐₓ at step S310. In an instance in which the comparison result obtained at step S310 indicates that the first time interval T₁ is not between Tₘᵢₙ and Tₘₐₓ, the method proceeds back to step S302 awaiting another initial contact signal. In an instance in which the comparison result obtained at step S310 indicates that the first time interval is less than Tₘₐₓ and greater than Tₘᵢₙ (the first time interval is between Tₘᵢₙ and Tₘₐₓ), the processing unit may determine whether the first and second sections with which the object came into contact in the first and second instances are the same section of the first scrolling region 210 at step S312. In an instance in which the first and second sections are the same section of the first scrolling region, the processing unit may determine whether the section is the initial section at step S314. If the result obtained at step S314 is YES, the method proceeds back to step 302 awaiting another initial contact signal.

In an instance in which the first and second sections are different sections of the first scrolling region, the processing unit may calculate and record a first direction D from the first section to the second section, and a first distance RD24 between the first section (e.g., section 212) and the second section (e.g., section 214) at step S316. The processing unit may then check whether more than two relative contact signals have been received at step S317. In the second instance, only one relative contact signal (the second contact signal) is received, and at least in this instance, the result obtained at step S317 is NO.

In instances in which the result obtained at step S314 or step S317 is NO, the processing unit may generate and output a scroll control signal at step S320. The scroll control signal may contain information of the direction D1 and distance RD24 that the processing unit recorded at step S316. In one example, the first direction D1 may be associated with an “upward” scrolling direction, and first distance RD24 between the first section and the second section may be associated with a first displacement (referred as “d24”). In this example, a user may be able to scroll a user interface window upward with the first displacement d24.

As the pointing object remains in contact with the second section, the processing unit may not detect a drop in the second contact signal at step S322. The sensing unit may continue to generate the second contact signal, which the processing unit may continue to receive. The processing unit may accordingly continue to generate and output the scroll control signal at step S320. This scroll control signal may include the same direction and distance as before. In an instance in which the processing ceases to receive the second contact signal or otherwise detects a drop in the second contact signal, which may be representative of removing or otherwise dragging or sliding the pointing object from the second section to another section, the method proceeds back to step S304. The processing unit then resets the timer awaits another contact signal at step S306.

In a third instance, the same or another pointing object may come into contact with a third section (e.g., section 215) in the first scrolling region 210, as illustrated in FIG. 4B. This third contact may, for example, be the result of the pointing object being moved along the touchpad 200 from the second section (e.g., section 214) to the third section (e.g., section 215). Similar to the first and second instances, the contact in the third instance may induce the sensing unit to generate another contact signal (e.g., a third contact signal) representative of contact with the third section of the first scrolling region 210. Similar to the first and second contact signals, the third contact signal (relative contact signal) may be received by the processing unit at step S306, and may be recognized by the processing unit as reflecting contact with the third section of the first scrolling region 210. A second time interval T₂ between the drop in the second contact signal and receipt of the third contact signal is recorded and compared to the first reference Tₘᵢₙ and second reference Tₘₐₓ at step S310. The processing unit may determine whether the second and third sections with which the object came into contact in the second and third instances are the same section of the first scrolling region 210 at step S312. In the instance illustrated in FIG. 4B, the pointing object comes into contact with different sections (sections 214 and 215) in the second and third instances. In this instance, the processing unit may calculate and record a direction D2 from the second section (section 214) to the third section (section 215), and a distance RD25 between the initial section (section 212) and the third section (section 215) at step S316.

The processing unit may check whether more than two relative contact signals have been received at step S317. In this instance, the second and third contact signals are both relative contact signals in that they are received within the time constraint of Tₘᵢₙ and Tₘₐₓ. The processing unit may then compare the direction (D2) recorded in present instance (third instance) to a direction (D1) recorded in the prior instance (second instance) at step S318. In the instance illustrated in FIG. 4B, the direction D2 is the same as the direction D1, the processing unit may then output a scroll control signal at step S320. The scroll control signal may contain information of the direction D2 and distance RD25 that the processing unit recorded at step S316. In one example, the direction D2 may be associated with an “upward” scrolling direction, and the distance RD25 may be associated with a displacement (referred as “d25”). In this example, a user may be able to scroll a user interface window upward with the displacement d25.

In an instance in which a pointing object lifts off the second section (section 214), producing a drop in the second contact signal that may be detected by the processing unit at step S322, and comes into contact with the same section (section 214) that induced the sensing unit to generate a third contact signal within the time constraint of Tₘᵢₙ to Tₘₐₓ at step S306, the processing unit may check whether the section with which the third contact comes into contact is the same as the section with which the prior contact (second contact) comes into contact at step S312. In the instance illustrated in FIG. 4C, for example, the third contact and the second contact come into contact with the same section (section 214). The processing unit may then check whether this section (section 214) is the initial section with which the initial contact signal comes into contact (e.g., the first contact signal in the first instance) at step S314. In the example shown in FIG. 4C, section 214 is not the initial section. The processing unit may then output a scroll control signal at step S320. The scroll control signal may contain the same information with respect to direction and distance (e.g., upward and distance RD24) that the processing unit recorded when the second contact signal comes into the second section, indicating that a user may, for example, be able to scroll a user interface window in the same scrolling direction (upward) with the same displacement (d24).

In an instance as illustrated in FIG. 4D in which a third contact comes into a third section such as the section 213, that has an opposite direction D2 from the section 214 to the section 213 (“downward”) than the first direction D1 from the section 212 to the section 214 (“upward”), which is compared and determined at step S318, the third contact signal is then defined as an initial contact signal at step S319. The method then proceeds back to step S304 awaiting another relative contact signal.

In various exemplary embodiments, the scroll operation that is executed downward in vertical scrolling region 210, or leftward and rightward in horizontal scrolling region 220 may similar to that executed upward in vertical scrolling region 210 described above.

According to one aspect of the present invention, as explained above, the touchpad may include, for example, a sensing unit and a processing unit. When a user's first finger is resting on the touchpad, the contact with the touchpad may be sensed by the sensing unit, which may be embodied in a number of different manners, such as in the form of a touch-sensitive surface. The processing unit may trigger the scroll control function to scroll documents in a specific scrolling direction with a specific displacement in response to direction and distance compared between contact signals received in sections in scrolling regions. The processing unit may be embodied in a number of different manners, such as a CPU (Central Processing Unit), microprocessor, coprocessor, controller and/or various other processing devices including integrated circuits such as ASIC (Application Specification Integrated Circuit), FPGA (Field Programmable Gate Array) or the like. As will be appreciated, the processing unit may include or otherwise be configured to communicate with memory, such as volatile memory and/or non-volatile memory, which may store data received or calculated by the processing unit, and may also store one or more software applications, instructions or the like for the processing unit to perform functions associated with operation of the device in accordance with exemplary embodiments of the present invention.

All or a portion of the system of the present invention, such as all or portions of the processing unit, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method for executing a scroll control operation on a touchpad, comprising:
receiving a first contact signal induced by a first contact with a first section of the touchpad;
receiving a second contact signal induced by a second contact with a second section of the touchpad, the first section and second section being predefined in a scrolling region on the touchpad;
recording a first direction from the first contact to the second contact, and a first distance between the first section and the second section; and
outputting a scroll control signal to execute a scroll operation, the scroll control signal including information of the first direction and first distance.

2. The method of claim 1, further comprising
recording a time interval between receipt of the first contact signal and second contact signal,
comparing the time interval to a first predefined reference and a second predefined reference, wherein the first reference is less than the second reference, and
recording the first direction and the first distance in at least one instance in which the time interval is between the first and the second references.

3. The method of claim 1, further comprising determining whether the first contact and the second contact come into contact with the same section.

4. The method of claim 1, further comprising
receiving a third contact signal induced by a third contact in a third section of the touchpad,
recording a second direction from the second contact to the third contact,
recording a second distance between the third section and the first section,
comparing the second direction to the first direction, and
entering an operation mode or an idle mode depending on the comparison result.

5. The method of claim 4, in an instance in which the second direction is the same as the first direction, further comprising outputting a second scroll control signal to execute a scroll operation, the scroll control signal including information of the second direction and second distance.

6. The method of claim 4, in an instance in which the second direction is different than the first direction, further comprising determining the third contact signal as a first contact signal and awaiting a second contact signal.

7. A device for executing a scroll control operation on a touchpad, the device comprising a processor configured to:
receive a first contact signal induced by a first contact with a first section;
receive a second contact signal induced by a second contact with a second section, the first section and second section being predefined in a scrolling region on the touchpad;
record a first direction from the first contact to the second contact and a first distance between the first section and the second section; and
output a first scroll control signal to execute a first scroll operation, the first scroll control signal including information of the first direction and the first distance.

8. The device of claim 7, wherein the device is further configured to record a time interval between receipt of the first contact signal and the second contact signal, compare the time interval to a predefined first reference and a predefined second reference, and wherein the first reference is less than the second reference, and record the first direction and the first distance in at least one instance in which the time interval is between the first and the second references.

9. The device of claim 7, wherein the device is further configured to determine whether the first contact signal and the second contact signal come into contact with the same section.

10. The device of claim 7, wherein the device is further configured to
receive a third contact signal induced by a third contact in a third section,
record a second direction from the second contact to the third contact,
record a second distance between the third section and the first section,
compare the second direction to the first direction, and
determine to enter an operation mode or an idle mode depending on the comparison result.

11. The device of claim 10, wherein in an instance in which the second direction is different than the first direction, the device is further configured to determine the second contact signal as a first contact signal and await another second contact signal.

12. The device of claim 10, wherein in an instance in which the second direction is the same as the first direction, the device is further configured to output a second scroll control signal to execute a scroll operation, the scroll control signal containing information of the second direction and second distance.

13. The device of claim 7, wherein the device is further configured to convert the distance to a displacement of a scroll bar.

14. A method for executing a scroll control operation on a touchpad, comprising:
receiving a first contact signal induced by a first contact with a first section of the touchpad;
receiving a second contact signal induced by a second contact with a second section of the touchpad, the first section and second section being predefined in a scrolling region on the touchpad;
recording a time interval between receipt of the first contact signal and second contact signal;
comparing the time interval to a predefined first reference and a predefined second reference;
recording a first direction from the first contact to the second contact and a distance between the first section and second section in an instance in which the time interval is less than the second reference and greater than the first reference; and
outputting a first scroll control signal to execute a scroll operation, the scroll control signal including information of the first direction and first distance.

15. The method of claim 14, further comprising:
receiving a third contact signal induced by a third contact with a third section,
recording a second direction from the second contact to the third contact, and
recording a second distance between the first section and the third section.

16. The method of claim 15, further comprising comparing the second direction to the first direction.

17. The method of claim 16, further comprising outputting a second scroll control signal, the second scroll control signal containing information of the second direction and second distance in an instance in which the second direction is the same as the first direction.

18. The method of claim 14, further comprising determining whether a contact signal and a prior contact signal come into contact with the same section.

19. A device for executing a scroll control operation on a touchpad, the device comprising a processor configured to:
receive a first contact signal induced by a first contact with a first section of the touchpad;
receive a second contact signal induced by a second contact with a second section of the touchpad, the first section and second section being predefined in a scrolling region on the touchpad;
record a time interval between receipt of the first contact signal and second contact signal;
compare the time interval to a predefined first reference and a predefined second reference;
record a first direction from the first contact to the second contact and a distance between the first section and second section in an instance in which the time interval is less than the second reference and greater than the first reference; and
output a first scroll control signal to execute a scroll operation, the scroll control signal including information of the first direction and first distance.

20. The device of claim 19, wherein the device is further configured to compare the second direction to the first direction, and to determine to enter an operation mode or an idle mode depending on the comparison result.
